(19) United States
(12) Patent Application Publication
(10) Pub. No.: US 2006/0219810 A1
(43) Pub. Date: Oct. 5, 2006

(54) Instrument for cleaning a vehicle undercarriage

(76) Inventor: Michel Saade, Framingham, MA (US)

Correspondence Address: KRIEGSMAN & KRIEGSMAN, 665 Franklin Street, Framingham, MA, 01702, US

(21) Appl. No.: 11/377,146

(22) Filed: Mar. 16, 2006

Related U.S. Application Data
(60) Provisional application No. 60/662,439, filed on Mar. 16, 2005.

(51) Int. Cl. B05B 1/20

(52) U.S. Cl. 239/159

(57) ABSTRACT

An instrument for cleaning the undercarriage of a motor vehicle includes an elongated, tubular support member that is adapted to receive an input supply of a particular fluid, such as water. The support member is connected in fluid communication with a generally rectangular cleaning head that is shaped to define a plurality of outputs through which the fluid is dispensed. The plurality of fluid outputs are arranged in first and second linear arrays, the second linear array of fluid outputs being disposed in a parallel and offset relationship relative to the first linear array of fluid outputs. A plurality of wheels are preferably connected to both the support member and the cleaning head. In this manner, the instrument can be easily rolled underneath the undercarriage of a vehicle.

### CROSS-REFERENCE TO RELATED APPLICATIONS

The present application claims the benefit under 35 U.S.C. 119(e) of U.S. provisional Patent Application Ser. No. 60/662,439, filed Mar. 16, 2005, the disclosure of which is incorporated herein by reference.

### BACKGROUND OF THE INVENTION

The present invention relates generally to cleaning instruments and more particularly to instruments designed for cleaning the undercarriage of an automotive vehicle.

An automotive vehicle (e.g., a car, truck or bus) is constantly subjected to a variety of harmful elements which tend to collect on its undercarriage. In particular, in cold weather regions, it has been found that the materials which are routinely dispensed to minimize roadway icing (e.g., salt, sand, etc.) often adhere to the undercarriage of most conventional vehicles. The collection of these materials on a vehicle undercarriage can, overtime, cause essential parts of the vehicle (e.g., exhaust pipes, muffler, etc.) to corrode (i.e., wear away). This wearing away of components can in turn necessitate significant vehicle maintenance and repair, thereby increasing the costs incurred by the owner of the vehicle during its lifetime.

Accordingly, it is often recommended that vehicle owners periodically clean the vehicle's undercarriage to minimize the corrosive effect of these harmful elements.

Commonly, a motor vehicle owner drives his/her vehicle through a conventional carwash in order to clean the vehicle's undercarriage. However, it has been found that this method of cleaning a vehicle undercarriage is relatively ineffective (i.e., significant levels of the corrosive elements often remain on the undercarriage after the cleaning process).

Based on the aforementioned ineffectiveness of most conventional carwashes, cleaning instruments have been created which are specifically designed to more adequately wash the undercarriage of a motor vehicle.

In U.S. Pat. No. 6,045,064 to M. A. Abraham (hereinafter the '064 patent), there is shown an a garden hose attachment for cleaning the underside of a vehicle which includes at least one elongated rigid tube having a pair of ends. At least one elbow conduit is coupled to one of the ends of the rigid tube. A single spray nozzle is connected to the elbow conduit. Also included is a spray gun mounted to one of the ends of the rigid tube. Upon the depression of a trigger of the spray gun, water is sprayed from the spray nozzle.

The spray device shown in the '064 patent (as well as devices of a similar design) suffers from a notable drawback. Specifically, due to its single nozzle design, the device shown in the '064 is only capable of outputting a single stream of water. The output of this single stream of water can only wash a relatively small area of the vehicle's undercarriage. As a result, in order to wash the entire undercarriage of a vehicle, the handler is required to significantly manipulate the device beneath the entire underside of the vehicle. As can be appreciated, it has been found that this significant manipulation requirement renders the device shown in the '064 patent considerably time consuming and labor intensive to use, which is highly undesirable.

In order to more efficiently clean the undercarriage of a vehicle, cleaning instruments have been devised which include more than one output (e.g, a hole, nozzle, or jet) through which a water stream can emanate.

For example, in U.S. Pat. No. 5,653,392 to J. H. Wells (hereinafter referred to as the '392 patent), there is shown a water jet cleaner for the underside of a vehicle. A plurality of jets are directed upwardly from a spray head which is mounted on a longitudinal member positioned closely to the ground on which the vehicle is resting. A handle is attached to the longitudinal member and wheels are mounted to the frame and the longitudinal member to allow manual reciprocal movement of the cleaner beneath the vehicle by an operator. The jets are angularly adjustable such that the cleaner may also be used to clean the surface itself such as a driveway.

The cleaner shown in the '392 patent (as well as cleaners of a similar design) suffers from a notable drawback. Specifically, the cleaner shown in the '392 patent configures its water jets in a linear arrangement. As a result, although the cleaner shown in the '392 is more efficient in cleaning the undercarriage of a vehicle than cleaners of the type described in the '064 patent, it is to be understood that the emanation of water cleaning streams along a single linear path still necessitates a considerable degree of user manipulation in order to adequately clean the entire undercarriage of the vehicle. As a result, the cleaner shown in the '392 patent has similarly been found to be time consuming and labor intensive to use, which is highly undesirable.

### SUMMARY OF THE INVENTION

It is an object of the present invention to provide a novel instrument for cleaning the undercarriage of a motor vehicle.

It is another object of the present invention to provide an instrument as described above which is adapted to dispense a fluid for cleaning the undercarriage of a motor vehicle.

It is yet another object of the present invention to provide an instrument as described above which includes a plurality of individual outputs through which the fluid is dispensed.

It is still another object of the present invention to provide an instrument as described above wherein the plurality of individual outputs are arranged in a non-linear array for greater fluid dispersion.

It is yet still another object of the present invention to provide an instrument of the type described above which has a limited number of parts, is inexpensive to manufacture and its easy to use.

Accordingly, there is provided an instrument for cleaning the undercarriage of a motor vehicle, said cleaning instrument comprising (a) a support member, and (b) a cleaning head in fluid communication with said support member, said cleaning head being shaped to define a first linear array of fluid outputs and a second linear array of fluid outputs, the second linear array of fluid outputs being disposed in a spaced apart and offset relationship relative to the first linear array of fluid outputs.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a side perspective view of a cleaning instrument constructed according to the teachings of the present invention;

FIG. 2 is an enlarged, fragmentary, top perspective view of the cleaning instrument shown in FIG. 1;

FIGS. 3(a)-(c) are various enlarged, fragmentary, top perspective views of the cleaning head shown in FIG. 2; and

FIG. 4 is an enlarged, fragmentary, side perspective view of the connector shown in FIG. 1.

### DETAILED DESCRIPTION OF THE PREFERRED EMBODIMENT

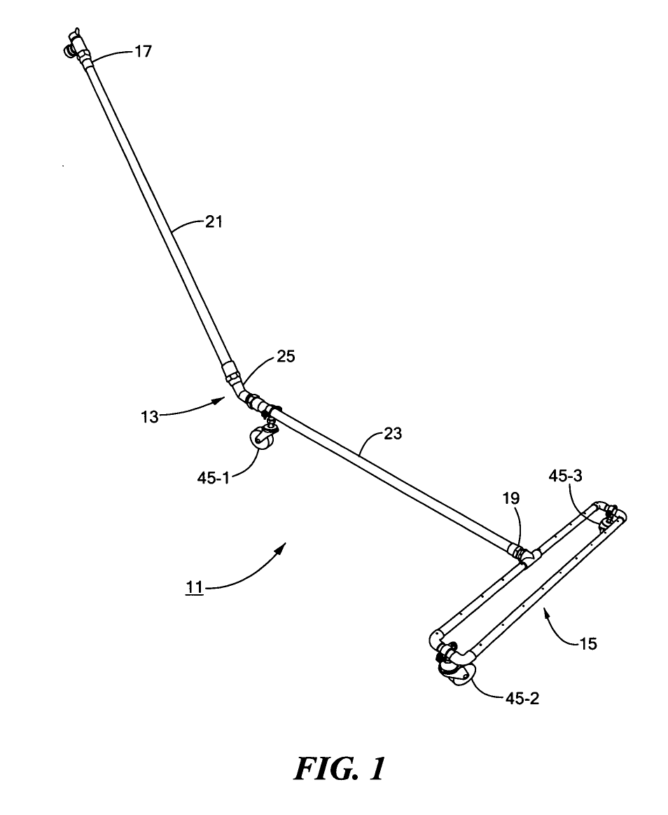

Referring now to FIG. 1, there is shown a cleaning instrument constructed according to the teachings of the present invention, the cleaning instrument being identified generally by reference numeral 11. As will be described further in detail below, cleaning instrument 11 is designed principally for use in cleaning the undercarriage of a motor vehicle, such as an automobile, truck or bus. However, it is to be understood that additional uses for cleaning instrument 11 could be derived without departing from the spirit of the present invention.

Cleaning instrument 11 includes a tubular support member 13 and a tubular cleaning head 15 which are connected together in fluid communication with one another. As will be described further below, a pressurized supply of a cleaning fluid, such as water, can be input into support member 13 and, in turn, is directed into cleaning head 15 where said cleaning fluid emanates out through a plurality of outputs to wash a vehicle undercarriage.

As seen clearly in FIG. 1, support member 13 is constructed as an elongated, multi-pieced tubular member which is approximately ¾ of an inch in diameter, said member including a first end 17 and a second end 19. Support member 13 includes a first length of copper pipe 21 and a second length of copper pipe 23 which are affixed together in fluid communication with one another by means of an elbow 25. It should be noted that the particular configuration of elbow 25 serves to dispose copper pipe 23 in a substantially horizontal position and to dispose copper pipe 21 at an obtuse angle relative to copper pipe 23 (i.e., such that first end 17 is disposed at the operator's hand-level).

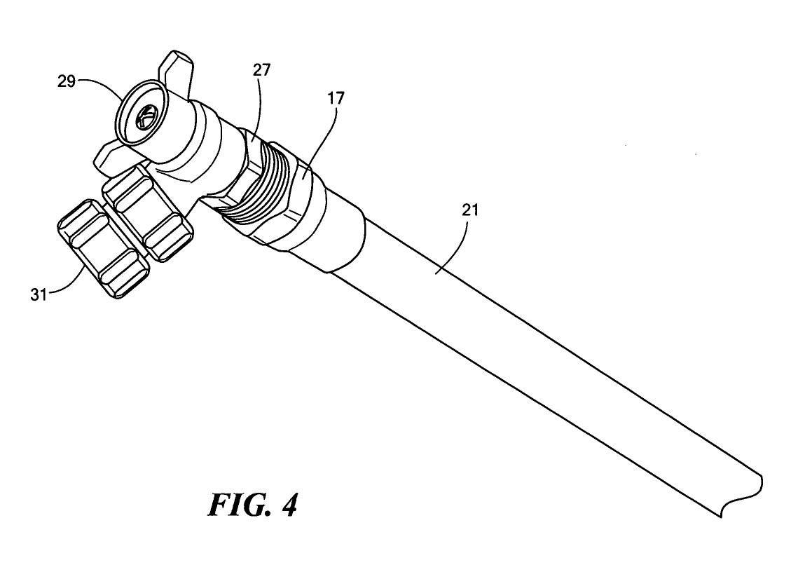

As seen most clearly in FIG. 4, a connector 27 is threadingly mounted onto first end 17 of support member 13. Connector 27 comprises a manual shut-off valve 29 and a threaded neck 31, neck 31 enabling a conventional garden hose to be secured in fluid connection therewith. In this manner, with a conventional garden hose connected to neck 31, a supply of water can be input into copper pipe 21 through first end 17, the input of said supply being regulated by shut-off valve 29.

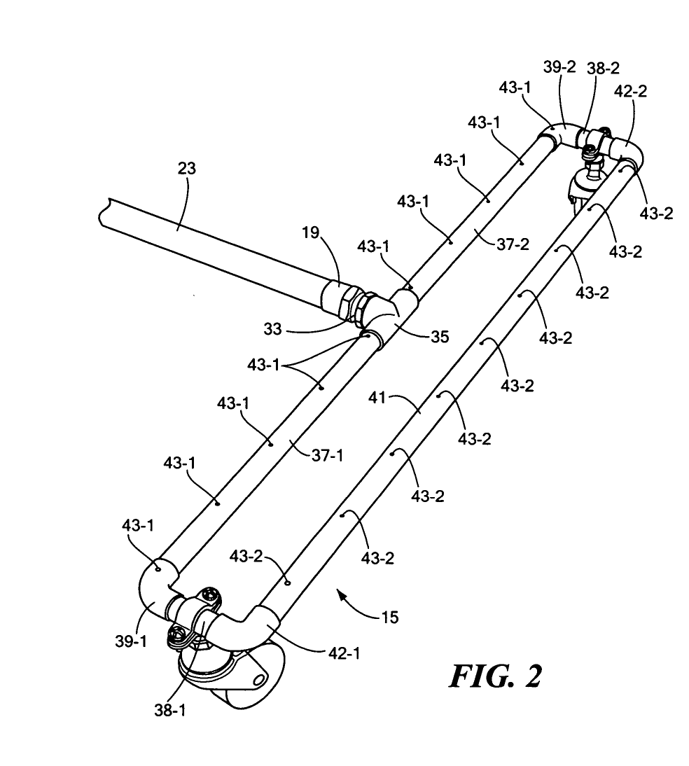

Referring now to FIG. 2, second end 19 of support member 13 is preferably provided with a threaded neck 33 on which cleaning head 15 can be mounted, as will be described further below.

Cleaning head 15 is constructed as a elongated, multi-pieced tubular member that is formed into a generally rectangular configuration, said tubular member being approximately ½ of an inch in diameter throughout its length. Specifically, cleaning head 15 comprises a T-shaped connector 35 which is adapted to be threadingly mounted onto threaded neck 33 of support member 13. In turn, a pair of copper pipes 37-1 and 37-2 are mounted onto the opposing free ends of T-shaped connector 35.

In addition, a pair of spacer pipes 38-1 and 38-2 are coupled to the free ends of copper pipes 37-1 and 37-2, respectively, through shortened, L-shaped connective pipes 39-1 and 39-2, respectively. In this manner, pipes 38-1 and 38-2 extend orthogonally relative to pipes 37-1 and 37-2, respectively.

Furthermore, an elongated copper pipe 41 is coupled to the free ends of spacer pipes 38-1 and 38-2 through shortened, L-shaped connective pipes 42-1 and 42-2, respectively. In this manner, it is apparent that co-linear pipes 37-1 and 37-2 are disposed in a spaced apart and parallel relationship relative to pipe 41.

Cleaning head 15 is shaped to define a plurality of fluid outputs 43 along a portion of its length, each output 43 being represented herein in the form of a circular hole that is created preferably through a simple drilling process. As will be described in greater detail below, the plurality of fluid outputs 43 are arranged so as to maximize the dispersion of fluid output therefrom, which is a principal object of the present invention. Specifically, a first linearly arranged set of outputs 43-1 is formed into pipes 37-1, 37-2, 39-1 and 39-2 along their length, adjacent outputs 43-1 being preferably spaced equidistantly apart from one another (e.g., by approximately 2.5 inches). Similarly, a second linearly arranged set of outputs 43-2 is formed into pipe 41 along the majority of its length, adjacent outputs 43-2 being preferably spaced equidistantly apart from one another (by approximately 2.5 inches).

Cleaning head 15 is shown as comprising ten outputs 43-1 which are spaced apart from one another in a linear arrangement and nine outputs 43-2 which are spaced apart from one another in a linear arrangement. However, it is to be understood that the number, size and shape of outputs 43 could be modified without departing from the spirit of the present invention.

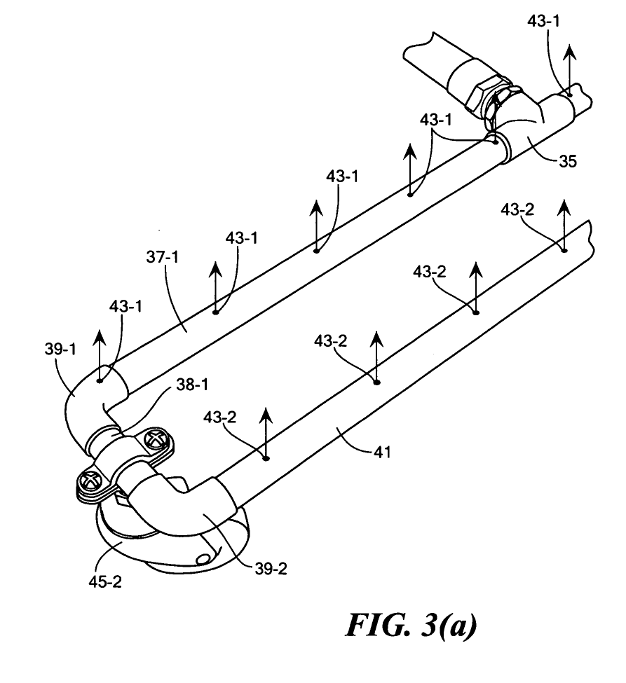

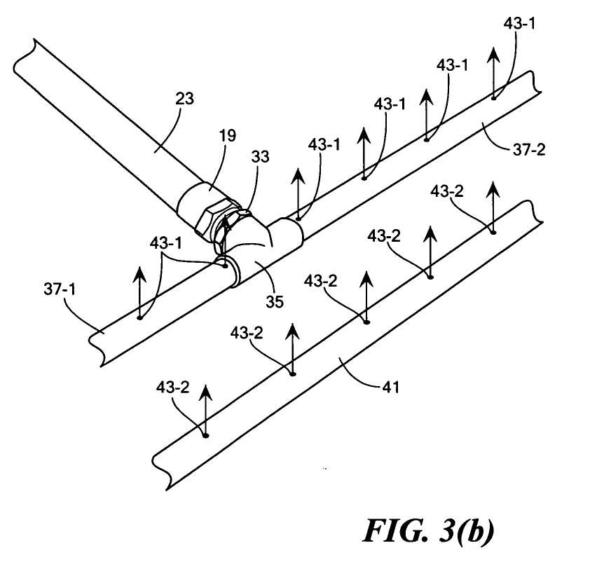

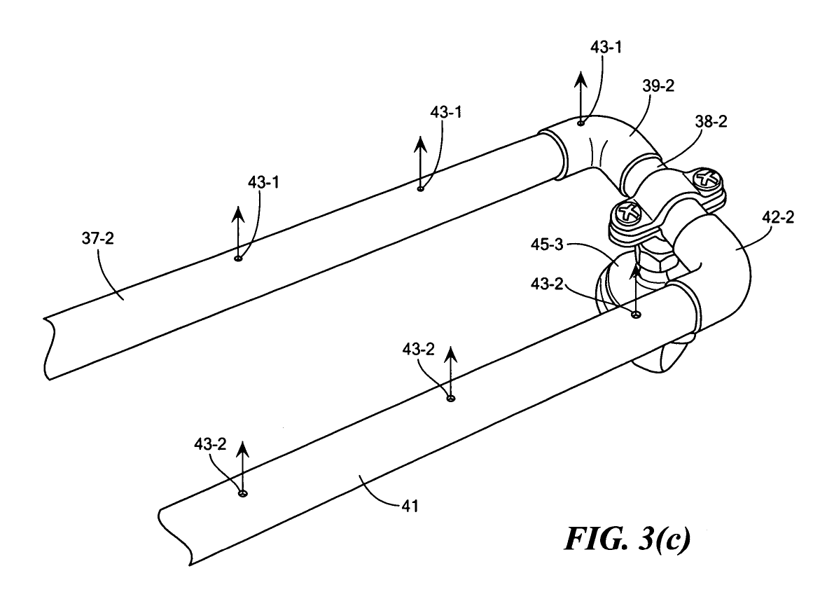

It should be noted that the first linear set of outputs 43-1 is offset from the second linear set of outputs 43-2. As a result, if pipe 41 were to be laid directly on top of pipes 37-1 and 37-2, each output 43-2 would align itself at the approximate midpoint between adjacent outputs 43-1 (as seen most clearly in FIGS. 3(a)-(c)). As can be appreciated, the offsetting, or staggering, of second set of outputs 43-2 relative to first set of outputs 43-1 serves to provide cleaning head 15 with a design which maximizes the surface area of the forceful output streams which are generated during use, thereby optimizing the efficiency of instrument 11, which is highly desirable.

Instrument 11 additionally includes a plurality of wheels 45 to assist in its manipulation under a vehicle. Specifically, instrument 11 includes a first wheel 45-1 which is coupled to pipe 23 proximate elbow 25. In addition, instrument includes a second wheel 45-2 coupled to pipe 38-1 (as seen most clearly in FIG. 3(a)) and a third wheel 45-3 coupled to pipe 38-2 (as seen most clearly in FIG. 3(c)). As can be appreciated, the three wheel design affords instrument 11 with a stable and accurate means of manipulation along a flat surface, such as the ground.

In use, instrument 11 can be used in the following manner to clean the undercarriage of a motor vehicle. Specifically, instrument 11 is disposed such that all wheels 45 contact the floor surface (i.e., as shown in FIG. 1). With instrument 11 configured as such, a conventional garden hose (or other similar water supply) is screwed onto threaded neck 31, thereby establishing fluid communication between the water supply and instrument 11. Grasping copper pipe 21 by hand (preferably proximate connector 27), the user can easily glide cleaning head 15 of instrument 11 beneath the vehicle's undercarriage (because of wheels 45).

As can be appreciated, with valve 29 disposed in its open position, the supply of water provided by the garden hose enters into pipe 21 through first end 17, travels the length of pipes 21 and 23 and passes into cleaning head 15 with a significant amount of pressure therebehind. As the water pressure enters into cleaning head 15, the water supply travels along pipes 37 and 41 and ultimately exits out through each output 43 as a powerful output stream (as represented by arrows in FIGS. 3(a)-(c)). Continued manipulation of instrument 11 (by hand) allows for the output streams of water to wash the entire underside of the vehicle in an efficient manner, which is a primary object of the present invention. It should be noted that, because linear array of outputs 43-2 is offset from linear array of outputs 43-1, instrument 11 can clean the entire undercarriage in the most efficient means possible (i.e., using the least number of passes of instrument 11 under the vehicle).

The embodiment shown of the present invention is intended to be merely exemplary and those skilled in the art shall be able to make numerous variations and modifications to them without departing from the spirit of the present invention.

As an example, it is to be understood that additional linear arrays of outputs could be provided in cleaning head 15 to increase the surface area of fluid dispersion generated therefrom without departing from the spirit of the present invention.

As another example, all of the tubular members and connectors of instrument 11 are preferably constructed using copper pipes. However, it is to be understood that the instrument 11 is not limited to the use of copper pipes for its tubular members and connectors. Rather, alternative types of conventional tubular materials (e.g., PVC tubing) could be used in place thereof without departing from the spirit of the present invention.

As yet another example, each fluid output 43 provided in cleaning head 15 is represented as a circular hole. However, it is to be understood that cleaning head 15 of instrument 11 is not limited to the use of circular holes for dispensing fluid. Rather, cleaning head 15 could be provided with alternative means for dispensing fluid (e.g., nozzles) without departing from the spirit of the present invention.

All such variations and modifications are intended to be within the scope of the present invention as defined in the appended claims.

What is claimed is:

1. An instrument for cleaning the undercarriage of a motor vehicle, said cleaning instrument comprising:
(a) a support member, and
(b) a cleaning head in fluid communication with said support member, said cleaning head being shaped to define a first linear array of fluid outputs and a second linear array of fluid outputs, the second linear array of fluid outputs being disposed in a spaced apart and offset relationship relative to the first linear array of fluid outputs.

2. The instrument as claimed in claim 1 wherein said support member is constructed as an elongated tubular member which includes a first end and a second end.

3. The instrument as claimed in claim 2 wherein the first end of said support member is adapted to connect with a conventional garden hose.

4. The instrument as claimed in claim 3 wherein the second end of said support member is adapted to releasably connect with said cleaning head.

5. The instrument as claimed in claim 1 wherein said cleaning head is constructed as an elongated tubular member that is formed into a substantially rectangular configuration.

6. The instrument as claimed in claim 5 wherein the first linear array of fluid outputs is disposed in parallel relative to the second linear array of fluid outputs.

7. The instrument as claimed in claim 6 wherein each fluid output provided in said cleaning head is in the form of a circular hole.

8. The instrument as claimed in claim 7 further comprising a plurality of wheels that are coupled to at least one of said support member and said cleaning head.
